(19) United States
(12) Patent Application Publication
(10) Pub. No.: US 2003/0062988 A1
(43) Pub. Date: Apr. 3, 2003

(54) Identification system having an identifiable object with a photo-activated microtransponder

(76) Inventors: Wlodek Mandecki, Princeton Junction, NJ (US); Michael Pappas, Lawrenceville, NJ (US); Hananel H. Davidowitz, Princeton, NJ (US)

Correspondence Address: BRINKS HOFER GILSON & LIONE, P.O. BOX 10395, CHICAGO, IL, 60610, US

(21) Appl. No.: 09/970,433

(22) Filed: Oct. 2, 2001

(51) Int. Cl. G07F 7/12

(52) U.S. Cl. 340/10.1; 340/5.86

(57) ABSTRACT

An identification system having a light source, an identifiable object and a receiver. The identifiable object having one or more photo-activated microtransponders operatively connected to an article. The photo-activated microtransponders are operative to transmit one or more output signals to the receiver in response to one or more light signals from the light source.

### CROSS REFERENCE

This application was filed on the same day as the following co-pending and commonly assigned U.S. patent application, which relates to and further describes other aspects of the embodiments disclosed in this application and is incorporated by reference in its entirety:

U.S. patent application Ser. No. ______, entitled MICROTRANSPONDER SENSING SYSTEM, having Attorney Reference Number 7295/45, filed on Oct. 2, 2001, and is now U.S. Pat. No. ______.

### FIELD

This invention relates generally to identification systems using electronic identification tags. More particularly, this invention relates to identification systems using photo-activated microtransponders that transmit identification information.

### BACKGROUND

Electronic transponders are used in a variety of applications to identify articles by storing and transmitting information. These applications include such diverse applications as the identification of wildlife, luggage, casino tokens and electronic article surveillance (EAS). A transponder functions by receiving a transmission request and, in turn, transmitting a response. This response usually is an identification signal and, often includes a serial number. Some transponders use a radio frequency identification (RFID) system. These systems operate without visual contact. Other transponders, such as those transponders in EAS systems, employ a closed loop of a conductive substance that responds to a generated radio frequency (RF) field. These transponders, also called tags due to their ability to “tag” a consumer item to prevent shoplifting, are deactivated when a product is purchased. EAS identification transponders typically are passive elements that respond only when placed in the appropriate RF or magnetic field. Some EAS information system transponders may transmit a description of the item to which the tag is affixed.

Many electronic transponders contain a battery or a solenoid to provide power, an internal oscillator to provide a clock signal and an external antenna to broadcast identification information. However, batteries, solenoids, oscillators, and external antennas restrict the ability to reduce the size of electronic transponders. Smaller transponders can be affixed to an article for identification without affecting use of the article.

Typical identification systems use a passive tag to avoid the need for a power supply. The passive tag requires generation of an RF or magnetic field to detect the tag. The passive tag needs to be relatively large to properly interact with, and be detected by, the RF or magnetic field. It often is impracticable to use an article with a passive tag attached because of the size of the passive tag. In addition, some articles are sensitive to RF interference, thus restricting the use of an RF or magnetic field.

### SUMMARY

The invention provides an identification system having a light source, an identifiable object with a microtransponder, and a receiver. The microtransponder transmits one or more output signals in response to a light signal. In one aspect, the identifiable object for an identification system has an article with one or more photo-activated microtransponders operatively connected to the article. The photo-activated microtransponders are operative to transmit one or more output signals in response to one or more light signals.

In another aspect, an identification system for an identifiable object has a light source, one or more photo-activated microtransponders and one or more receivers. The one or more photo-activated microtransponders are operatively connected to an article. The photo-activated microtransponders transmit an output signal in response to one or more light signals from the sources. The receiver detects the one or more output signals.

In a method for identifying an identifiable object having at least one photo-activated microtransponder operatively connected to an article the one or more photo-activated microtransponders are activated with one or more light signals. One or more output signals are transmitted in response to one or more light signals. One or more output signals are detected.

Other systems, methods, features, and advantages of the invention will be or will become apparent to one skilled in the art upon examination of the following figures and detailed description. All such additional systems, methods, features, and advantages are intended to be included within this description, within the scope of the invention, and protected by the accompanying claims.

### BRIEF DESCRIPTION OF THE FIGURES

The invention may be better understood with reference to the following figures and detailed description. The components in the figures are not necessarily to scale, emphasis being placed upon illustrating the principles of the invention. Moreover, like reference numerals in the figures designate corresponding parts throughout the different views.

FIG. 1 is a block diagram of an identification system having an identifiable object with a photo-activated microtransponder operatively connected to an article, a light source supplying a light signal to the photo-activated microtransponder, an output signal generated by the photo-activated microtransponder, and a receiver detecting the output signal generated by the photo-activated microtransponder according to an embodiment.

FIG. 2 represents a block diagram of and identifiable object having a photo-activated microtransponder operatively connected to an article according to an embodiment.

FIG. 3 represents a top view of a photo-activated microtransponder according to one embodiment.

FIG. 4 is a top view of an identifiable object having a photo-activated microtransponder operatively connected to a surface of an article according to an embodiment.

FIG. 5 is a section view of an identifiable object having a photo-activated microtransponder operatively connected to a surface of an article according to an embodiment.

FIG. 6 is a section view of an identifiable object having a photo-activated microtransponder operatively connected by embedding in a recess at a surface of an article where the photo-activated microtransponder protrudes above the surface of the article according to an embodiment.

FIG. 7 is a section view of an identifiable object having a photo-activated microtransponder operatively connected by embedding in a recess at a surface of an article where the photo-activated microtransponder is flush with the surface of the article according to an embodiment.

FIG. 8 is a section view of an identifiable object having a photo-activated microtransponder operatively connected by embedding in a recess at a surface of an article where the photo-activated microtransponder is below the surface of the article according to an embodiment.

FIG. 9 is a section view of an identifiable object having a photo-activated microtransponder operatively connected by embedding under a surface of the article according to an embodiment.

FIG. 10 is a section view of an identifiable object having a photo-activated microtransponder operatively connected by embedding in a recess at a surface of an article where the photo-activated microtransponder is below the surface of the article and covered by a translucent cover according to an embodiment.

### DETAILED DESCRIPTION OF THE PREFERRED EMBODIMENTS

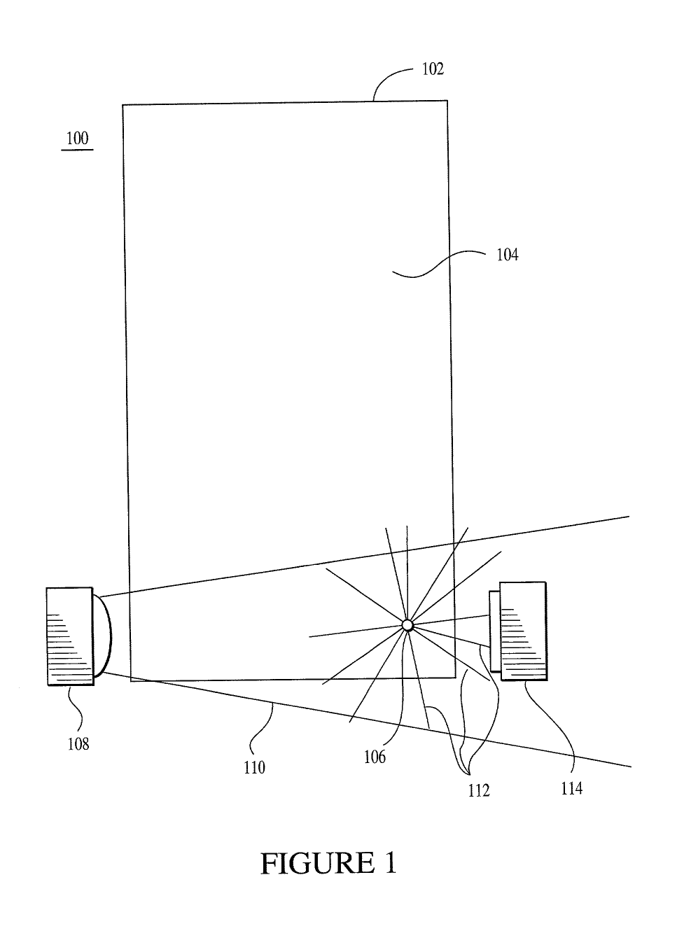

FIG. 1 represents a block diagram of an identification system 100 for an identifiable object 102 having a photo-activated microtransponder 106 according to an embodiment. The identification system 100 comprises an identifiable object 102, a light source 108, and a receiver 114. The identifiable object 102 comprises a photo-activated microtransponder 106 operatively connected to an article 104. The light source 108 supplies a light signal 110. The photo-activated microtransponder 106 transmits an output signal 112 in response to a light signal 110. The receiver 114 detects the output signal 112.

A photo-activated microtransponder 106 is smaller than the article 104 and is sized to essentially not interfere with the use of the article. In one aspect, the photo-activated microtransponder 106 has dimensions of less than about 700 microns in height, less than about 700 microns in width, and less than about 200 microns in depth. In another aspect, the photo-activated microtransponder 106 has dimensions of less than about 500 microns in height, less than about 500 microns in width, and less than about 150 microns in depth. In a further aspect, the photo-activated microtransponder 106 has a volume of about 98,000,000 cubic microns. In yet another aspect, the photoactivated microtransponder 106 has a volume of less than about 37,500,000 cubic microns. With these dimensions, an article 104 may be used while a photo-activated microtransponder 106 is affixed.

The photo-activated microtransponder 106 is operatively connected to an article 104 to create an identifiable object 102. The article 104 may be comprised of paper, plastic, fabric, metal and other material and combinations thereof. The article 104 may be a piece of paper, a compact disk (CD), a digital video disk (DVD), a laser disk (LD), a credit card, a debit card, a magnetic disk, a smart card and the like. The article 104 may be rigid such as a CD, non-rigid such as a piece of fabric, or have an intermediate form of structure.

The photo-activated microtransponder 106 can be operatively connected to an article 104 that is optically read, magnetically read, electronically read and the like as well as articles 104 which employ combinations of optical read, magnetic read, electronic read and the like. An optically read article 104 includes a piece of paper, a CD, a DVD, a LD, a credit card, a debit card, a smart card and the like. A magnetically read articles 104 includes a piece of paper, a credit card, a debit card, a magnetic disk, a smart card and the like. An electronically read article 104 includes smart cards and the like.

The photo-activated microtransponder 106 has a photosensitive element (not shown) that receives a light signal 110 from a light source 108 and converts it into a supply voltage. In one aspect, the photo-activated microtransponder 106 utilizes a photodiode as the photosensitive element that receives a light signal 110 from a light source 108 and converts it into a supply voltage. The photo-activated microtransponder 106 may utilize any photosensitive element capable of receiving a light signal and converting it into a supply voltage. In one aspect, the photo-activated microtransponder 106 receives the modulating component of the light signal 110 from the light source 108 and constructs a clock signal. In another aspect, the photo-activated microtransponder 106 receives both a light signal 110 to convert into a supply voltage and a modulating component of a light signal 110 to construct a clock signal. The photo-activated microtransponder 106 stores an identification number or other data. When activated the photo-activated microtransponder 106 accesses the identification number or other data. The photo-activated microtransponder 106 modulates and transmits the identification or other data as output signal 112 to the receiver 114.

A photo-activated microtransponder 106 transmits a signal when one or more light signals 110 are supplied. Therefore, an identification system 100 utilizing a photo-activated microtransponder 106 does not require the generation of an appropriate radio frequency (RF) or magnetic field to detect or activate a photo-activated microtransponder 106. Because the generation of appropriate RF or magnetic fields are not necessary to activate a photoactivated microtransponder 106, photo-activated microtransponders 106 can be utilized in areas and systems where it is necessary or desired to keep RF or magnetic field generation to a minimum or where a high signal to noise ratio during photo-activated microtransponder 106 activation is desired.

The light signal 110, which is converted into a supply voltage can be supplied by any light source capable of activating a photosensitive element. In one aspect the light source 108 can be anything capable of generating a light signal 110 with a specific frequency such as a LASER, an LED and the like. In a further aspect, the light source produces a light signal with a wavelength in the range from about 500 nanometers to about 1,200 nanometers, more specifically, from about 600 nanometers to about 800 nanometers. In still another aspect the light source produces a light signal with a wavelength in the range of about 670 nanometers to about 690 nanometers.

In one aspect, the photo-activated microtransponder 106 receives a light signal 110 from a light source 108 to create a supply voltage and transmit an output signal 112. In another aspect, the photo-activated microtransponder 106 receives the modulating component of the light signal 110 from the light source 108 and constructs a clock signal and transmit an output signal 112. In another aspect, the photo-activated microtransponder 106 receives both a light signal 110 to convert into a supply voltage and a modulating component of a light signal 110 to construct a clock signal to produce an output signal 112.

A photo-activated microtransponder 106 stores an identification number or other data. When a light signal is supplied to the photo-activated microtransponder 106, the photo-activated microtransponder 106 modulates and transmits the identification or other data as output signal 112 to the receiver 114.

A modulating component of a light signal 110 can have a frequency in a range of about 100 kHz to about 1,000 MHz according to one aspect. In another aspect, the output signal 112 can have a frequency in a range of about 0.5 MHz to about 2 MHz.

A output signal 112 from the photo-activated microtransponder can include an electronic signal, a magnetic signal, an optical signal and the like as well as various combinations the above mentioned signals. The output signal 112 can have a frequency in a range of about 100 kHz to about 1,000 MHz according to one aspect. In another aspect, the output signal 112 can have a frequency in a range of about 0.5 MHz to about 2 MHz. In one aspect the output signal 112 may be a coded signal.

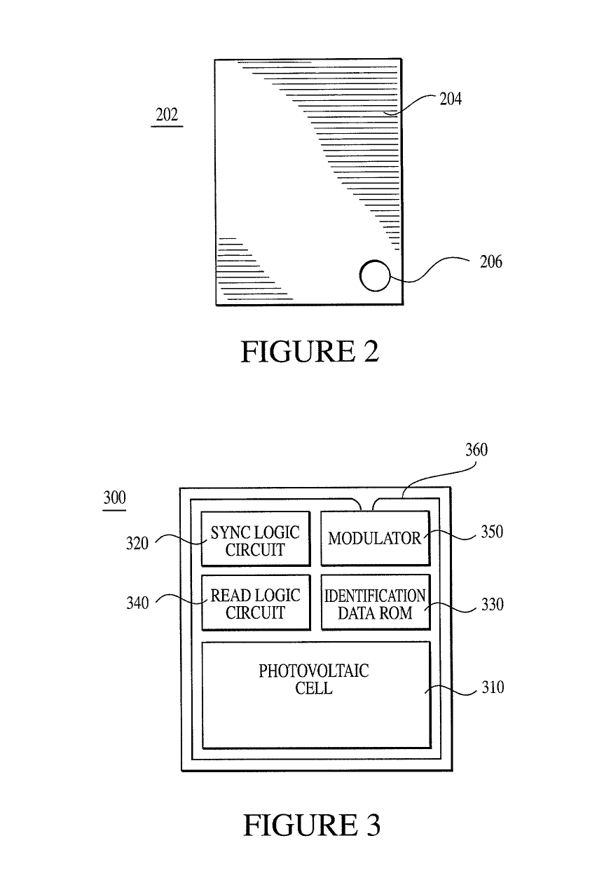

FIG. 2 represents a block diagram of an identifiable object 202 according to one embodiment. A photo-activated microtransponder 206 is operatively connected to an article 204. Operatively connected includes an attachment medium, attachment configuration, other means for affixing the photo-activated microtransponder 206 to the article 204, and combinations thereof. Attachment medium includes adhesives, bonding agents, resins, solders, and the like to attach the photo-activated microtransponder 206 to the article 204. Attachment configuration includes structural adaptations of the article 204 to hold or otherwise secure the photo-activated microtransponder 206 to the article. These structural adaptations include a pressure fit where differences exist between the size and shape of the photo-activated microtransponder 206 and a recess in the article 204 into which the photo-activated microtransponder 206 is inserted. The compression of the article 204 against the photo-activated microtransponder 206 in the recess creates a “pressure fit” to hold the photo-activated microtransponder 206 in place. Other configurations may be used to form a pressure fit. Other structural adaptations may also be used.

As an article 204 can be used in a normal fashion with a photoactivated microtransponder 206 attached, the photo-activated microtransponder 206 can be used as an authentication feature for an article 204. An article 204 such as a piece of paper, CD, DVD, LD, credit card, debit card, magnetic disk, smart card, driver license, passport, visa and the like can be verified as original if a photo-activated microtransponder 206 is affixed and the proper output signal is transmitted in response to activation of the photoactivated microtransponder 206.

When a photo-activated microtransponder 206 is attached to an article 204 such as a piece of paper the photo-activated microtransponder 206 can act as a verification feature to show the paper 204 is genuine and not a copy. Further, when a photo-activated microtransponder 206 is attached to an article 204 such as a CD, DVD, LD, credit card, debit card, magnetic disk, smart card, driver license, passport, visa and the like, the photo-activated microtransponder 206 can be utilized as a security feature to prevent the unauthorized access of the information on such article 204. When a photo-activated microtransponder 206 is attached to a CD, DVD, LD, credit card, debit card, magnetic disk, smart card, driver license, passport, visa and the like, the photo-activated microtransponder 206 can be utilized as an authentication feature to prevent access to information that has been duplicated, distributed and the like from an authentic article 204 to a non-authentic article 204. In such systems, a photo-activated microtransponder 206 would increase the difficulty of pirating music, video, copyrighted information, computer software and the like that occurs when traditional CD's, DVD's, LD's, credit cards, debit cards, magnetic disks, smart cards, driver licenses, passports, visas and the like are used by the public.

FIG. 3 represents a top view of a photo-activated microtransponder 300 according to an embodiment. The photo-activated microtransponder 300 comprises a photovoltaic cell 310, a sync logic circuit 320, identification data read only memory (ROM) 330, a read logic circuit 340, a modulator 350, and an antenna 360. The photovoltaic cell 310 comprises a photodiode and may comprise any photosensitive element that receives a light signal and converts it into an electric signal. The sync logic circuit 320 receives the modulating component of the light signal and constructs a clock signal. The identification data ROM 330 stores an identification number for the photo-activated microtransponder. Driven by the clock signal, the read logic circuit 340 accesses the identification data ROM 330 to retrieve the unique identification number or other data. Next, the modulator 350 modulates an output signal. Finally, the antenna 360 transmits the output signal. The photo-activated microtransponder 300 may have other configurations including fewer, additional or other components.

A photo-activated microtransponder can be configured to generate an output signal in response to the generation of power, in response to the generation of a clock signal, or upon both the generation of power and a clock signal.

A photo-activated microtransponder 300 can require a light signal or plurality of light signals of a specific wavelength, modulated at a specific rate, illuminated at a specific intensity, and the like, as well as a combination of wavelength, modulation, intensity and the like can be required to activate a photo-activated microtransponder 300 and produce an output signal. For example, the photo-activated microtransponder 300 can be configured to transmit an output signal whenever a specific light signal, such as a light amplification by stimulated emission of radiation (LASER) or a light emitting diode (LED) is present to power the photo-activated microtransponder. The photo-activated microtransponder 300 can be further configured to require a specific frequency or frequencies of light signals to generate a corresponding output signal, or a plurality of output signals. The photo-activated microtransponder 300 can be programmed to transmit an output signal whenever a modulated light signal, such as a LASER or an LED is modulated at a specific frequency to generate a clock signal. The use of such light signals allows for a great deal of selectively in the activation of a photoactivated microtransponder 300, even when there are a great number of photo-activated microtransponders 300 in a small area.

Due to the size of a photo-activated microtransponder 300, it is possible to attach a plurality of photo-activated microtransponders 300 to an article. Attaching a plurality of photo-activated microtransponders 300 to an article creates the capacity to transmit multiple output signals from multiple photo-activated microtransponders 300 attached to the same article.

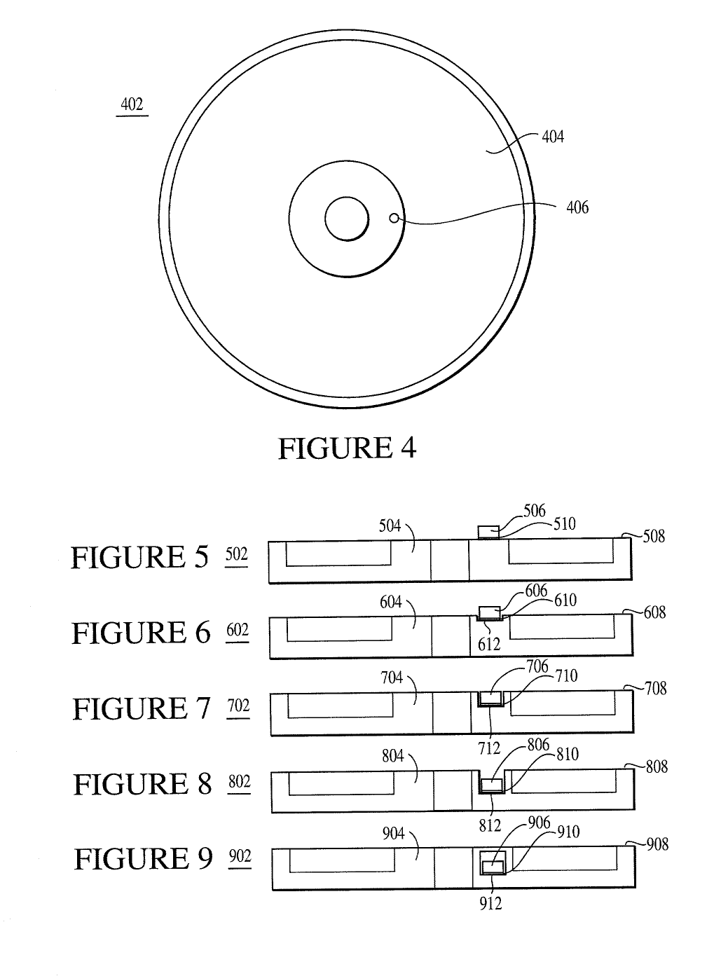

FIG. 4 represents a block diagram of an identifiable object 402 according to another embodiment. A photo-activated microtransponder 406 is operatively connected to an article 404. A translucent cover (not shown) and described below may cover the photo-activated microtransponder 406. As previously discussed, operatively connected includes an attachment medium, attachment configuration, other means for affixing the photo-activated microtransponder 406 to the article 404, and combinations thereof.

A photo-activated microtransponder 406 can be operatively connected to an article 404 in a variety of locations. A photo-activated microtransponder 406 can be operatively connected to a surface of the article 404, operatively connected in a recess at a surface of the article 404, operatively connected by embedding under a surface of the article 404, and the like. Further, it should be recognized that multiple photo-activated microtransponders 406 can be operatively connected to an article 404 in the previously discussed locations as well as various combinations of the previously disclosed locations. A photo-activated microtransponder 406 can be operatively connected to an article 404 during or sometime after the manufacture of such article 404.

A photo-activated microtransponder 406 can be operatively connected to an article by a variety of means. A photo-activated microtransponder 406 can be operatively connected to an article 404 by an attachment mechanism, an attachment configuration, a combination of an attachment mechanism and an attachment configuration and the like. An attachment mechanism can include adhesives, bonding agents, resins, solders, and the like as well as various combinations thereof.

An attachment configuration includes structural adaptations of the article 404 to hold or otherwise secure the photo-activated microtransponder 406 to the article. These structural adaptations include a pressure fit where differences exist between the size and shape of the photo-activated microtransponder 406 and a recess in the article 404 into which the photoactivated microtransponder 406 is inserted. The compression of the article 404 against the photo-activated microtransponder 406 in the recess creates a “pressure fit” to hold the photo-activated microtransponder 406 in place. Other configurations may be used to form a pressure fit. Other structural adaptations may also be used.

FIG. 4 shows a photo-activated microtransponder 406 operatively connected to an article 404 where the article 404 is a CD 404 or similar optically read article such as a DVD and a LD. The article 404 may be other articles as previously discussed. Such operative connection can occur at various areas of the CD 404. In one aspect, the operative connection takes place near the center of the CD 404. In another aspect, the operative connection takes place between an inner edge of the CD 404, which defines a circular hole in the CD 404, and the area of the CD 404 containing recordable material. In a further aspect, the operative connection takes place between the area of the CD 404 containing recordable material and the outer edge of the CD 404. In still another aspect, the operative connection can take place in the area of the CD 404 containing recordable material.

FIGS. 5 to 9 represent sectional views of an identifiable object according to various embodiments. FIG. 5 represents a sectional view of an identifiable object 502 having a photo-activated microtransponder 506 operatively connected 510 on a surface 508 of an article 504 according to one embodiment. Such operative connection 510 can take place on a surface 508 at various locations of the article 504 as previously described and may use various attachment mediums and attachment configurations as well as combinations thereof as previously discussed.

FIG. 6 represents a sectional view of an identifiable object 602 having a photo-activated microtransponder 606 operatively connected 610 by embedding in a recess 612 on a surface 608 of an article 604 according to one embodiment. FIG. 6 shows a photo-activated microtransponder 606 that protrudes above the surface 608 of the article 604. Such operative connection 610 can take place on a surface 608 at various locations of the article 604 as previously described and may use various attachment mediums and attachment configurations as well as combinations thereof as previously discussed.

FIG. 7 represents a sectional view of an identifiable object 702 having a photo-activated microtransponder 706 operatively connected 710 by embedding in a recess 712 on a surface 708 of an article 704 according to one embodiment. FIG. 6 shows a photo-activated microtransponder 706 that is flush with the surface 708 of the article 704. Such operative connection 710 can take place on a surface 708 at various locations of the article 704 as previously described and may use various attachment mediums and attachment configurations as well as combinations thereof as previously discussed.

FIG. 8 represents a sectional view of an identifiable object 802 having a photo-activated microtransponder 806 operatively connected 810 by embedding in a recess 812 on a surface 808 of an article 804 according to one embodiment. FIG. 8 shows a photo-activated microtransponder 806 that is recessed below the surface 808 of the article 804. Such operative connection 810 can take place on a surface 808 at various locations of the article 804 as previously described and may use various attachment mediums and attachment configurations as well as combinations thereof as previously discussed.

FIG. 9 represents a sectional view of an identifiable object 902 having a photo-activated microtransponder 906 operatively connected 910 by embedding under a surface 908 in a recess 912 of an article 904 according to one embodiment. The recess 912 may be preformed in the article 904 and may be formed by conforming the article 904 around the photo-activated microtransponder 906. Such operative connection 910 can take place under a surface 908 at various locations of the article 904 as previously described and may use various attachment mediums and attachment configurations as well as combinations thereof as previously discussed.

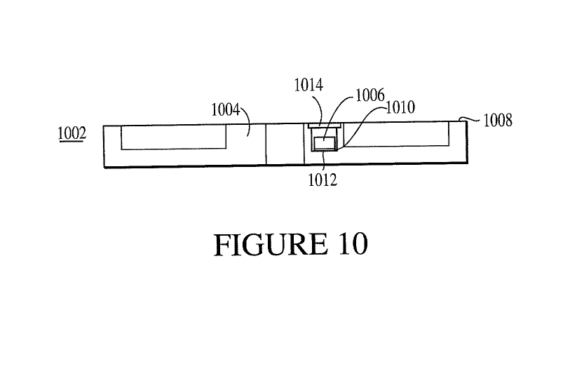

FIG. 10 represents a sectional view of an identifiable object 1002 having a photo-activated microtransponder 1006 operatively connected 1010 by embedding under a surface 1008 in a recess 1012 and covered by a translucent cover 1014 in an article 1004 according to one embodiment. The recess may be preformed in the article 1004 and may be formed by conforming the article 1004 around the photo-activated microtransponder 1006. The translucent cover 1014 may be a separate component and may be formed as part of the article 1004. The article 1004 may comprise a translucent material as discussed below. Such operative connection 1010 can take place under a surface 1008 at various locations of the article 1004 as previously described and may use various attachment mediums and attachment configurations as well as combinations thereof as previously discussed.

The translucent cover 1014 may comprise plastic, glass, silicon, germanium and the like. The translucent cover 1014 may comprise material that is essentially opaque to the visible light spectrum—the portion of the electromagnetic spectrum which is visible to the human eye—while allowing the transmission of the output signal and the frequencies used to activate the photo-activated microtransponder 1006. The translucent cover 1014 may comprise any material that passes a light signal and an output signal essentially unaffected. The translucent cover 1014 may be opaque to the visible light spectrum while permitting the transmission of ultraviolet and higher frequencies as well as infrared and lower frequencies. Opaque includes effectively blocking or preventing the transmission of one or more portions of the electromagnetic spectrum. In one aspect, a plastic material or plastic like material, similar to that used in infrared remote controllers for televisions, video cassette recorders, CD players, DVD players, LD players and the like, can be used as the translucent cover 1014. The plastic material translucent cover 1014 can be opaque to electromagnetic frequencies visible to the human eye while remaining transparent to other electromagnetic signals outside the range visible to the human eye.

Various embodiments of the invention have been described and illustrated. However, the description and illustrations are by way of example only. Other embodiments and implementations are possible within the scope of this invention and will be apparent to those of ordinary skill in the art. Therefore, the invention is not limited to the specific details, representative embodiments, and illustrated examples in this description. Accordingly, the invention is not to be restricted except in light as necessitated by the accompanying claims and their equivalents.

What is claimed is:

1. An identifiable object for an identification system comprising:
an article;
at least one photo-activated microtransponder operatively connected to the article, the photo-activated microtransponder to transmit at least one output signal in response to at least one light signal.

2. The identifiable object for an identification system according to claim 1, where the photo-activated microtransponder has dimensions of less than about 700 microns in height, by about 700 microns in width, by about 200 microns in depth.

3. The identifiable object for an identification system according to claim 2 where the photo-activated microtransponder has dimensions of less than about 500 microns in height, by less than about 500 microns in width, by less than about 150 microns in depth.

4. The identifiable object for an identification system according to claim 1, where the photo-activated microtransponder has a volume of about 98,000,000 cubic microns.

5. The identifiable object for an identification system according to claim 4, where the photo-activated microtransponder has a volume of less than about 37,500,000 cubic microns.

6. The identifiable object for an identification system according to claim 1, where the article comprises at least one of paper, plastic, fabric, and metal.

7. The identifiable object for an identification system according to claim 1, where the article comprises at least one of an optically-read article, a magnetically-read article and an electronically-read article.

8. The identifiable object for an identification system according to claim 7, where the optically-read article comprises at least one of a compact disk (CD), a digital video disk (DVD), a laser disk (LD) and a personal identification document.

9. The identifiable object for an identification system according to claim 8, where the personal identification document comprises one of an identification card, a driver's license, a passport and a visa.

10. The identifiable object for an identification system according to claim 7, where the magnetically-read article comprises at least one of a credit card, a debit card, a magnetic disk and paper.

11. The identifiable object for an identification system according to claim 7, where the electronically-read article comprises a smart card.

12. The identifiable object for an identification system according to claim 1, where the at least one photo-activated microtransponder comprises a photovoltaic power supply.

13. The identifiable object for an identification system according to claim 12, where a supply voltage is generated in response to the at least one light signal, and where the at least one photo-activated microtransponder transmits the at least one output signal in response to the supply voltage.

14. The identifiable object for an identification system according to claim 1, where the at least one light signal comprises a modulated light signal, and where the at least one photo-activated microtransponder generates a clock signal in response to the modulated light signal.

15. The identifiable object for an identification system according to claim 14, where the at least one photo-activated microtransponder transmits the at least one output signal in response to the clock signal.

16. The identifiable object for an identification system according to claim 1, where the at least one photo-activated microtransponder is disposed on a surface of the article.

17. The identifiable object for an identification system according to claim 1, where the at least one photo-activated microtransponder is embedded in the article.

18. The identifiable object for an identification system according to claim 17, where the at least one photo-activated microtransponder is embedded in a recess in a surface of the article.

19. The identifiable object for an identification system according to claim 18, further comprising a translucent cover disposed in the recess to cover the photo-activated microtransponder.

20. The identifiable object for an identification system according to claim 19, where the translucent cover is essentially opaque to the visible light portion of the electromagnetic spectrum.

21. The identifiable object for an identification system according to claim 17, where the at least one photo-activated microtransponder is embedded under a surface of the article.

22. The identifiable object for an identification system according to claim 1, where the at least one photo-activated microtransponder is operatively connected to the article by at least one of an attachment medium and an attachment configuration.

23. The identifiable object for an identification system according to claim 22, where the attachment medium is at least one of an adhesive, a bonding agent, a resin, and a solder.

24. The identifiable object for an identification system according to claim 22, where the attachment configuration is a structural adaptation.

25. The identifiable object for an identification system according to claim 1, where the at least one light signal is a modulated signal.

26. The identifiable object for an identification system according to claim 1, where the at least one output signal comprises at least one of an electronic signal, a magnetic signal, and an optical signal.

27. The identifiable object for an identification system according to claim 1, where the at least one output signal comprises a coded signal.

28. An identification system for an identifiable object comprising:
a light source;
at least one photo-activated microtransponder operatively connected to an article, where the at least one photo-activated microtransponder transmits at least one output signal in response to at least one light signal from at least one light source; and
at least one receiver operative to detect the at least one output signal.

29. The identification system for an identifiable object according to claim 28, where the article is comprised of at least one of paper, plastic, fabric, and metal.

30. The identification system for an identifiable object according to claim 28, where the article comprises at least one of an optically-read article, a magnetically-read article and an electronically-read article.

31. The identification system for an identifiable object according to claim 28, where the at least one light signal comprises a modulated light signal.

32. The identification system for an identifiable object according to claim 31, where the at least one photo-activated microtransponder generates a clock signal in response to the modulated light signal.

33. The identification system for an identifiable object according to claim 32, where the output signal is a modulated signal.

34. The identification system for an identifiable object according to claim 31, where the output signal is a modulated signal.

35. The identification system for an identifiable object according to claim 31, where the modulated signal has a frequency in a range of about 100 kHz to about 1,000 MHz.

36. The identification system for an identifiable object according to claim 35, where the modulated signal has a frequency in a range of about 0.5 MHz to about 2 MHz.

37. The identification system for an identifiable object according to claim 28, where the output signal is a modulated signal.

38. The identification system for an identifiable object according to claim 28, where the at least one photo-activated microtransponder generates a clock signal in response to the modulated light signal.

39. The identification system for an identifiable object according to claim 38, where the output signal is a modulated signal.

40. The identification system for an identifiable object according to claim 28, where the at least one photo-activated microtransponder is disposed on a surface of the article.

41. The identification system for an identifiable object according to claim 28, where the at least one photo-activated microtransponder is embedded in the article.

42. The identification system for an identifiable object according to claim 28, where the at least one photo-activated microtransponder is operatively connected to the article by at least one of an attachment medium and an attachment configuration.

43. The identification system for an identifiable object according to claim 28, where the at least one light source comprises at least one of a light amplification by stimulated emission of radiation (LASER) and a light emitting diode (LED).

44. The identification system for an identifiable object according to claim 28, where the light signal has a wavelength in a range of about 500 nanometers to about 1,200 nanometers.

45. The identification system for an identifiable object according to claim 44, where the light signal has a wavelength in a range of about 670 nanometers to about 690 nanometers.

46. The identifiable object for an identification system according to claim 28, where the at least one output signal comprises at least one of an electronic signal, a magnetic signal, and an optical signal.

47. The identifiable object for an identification system according to claim 46, where the electronic signal is a radio frequency signal.

48. The identifiable object for an identification system according to claim 28, where the at least one output signal has a frequency in a range of about 100 kHz to about 1,000 MHz.

49. The identifiable object for an identification system according to claim 48, where the at least one output signal has a frequency in a range of about 0.5 MHz to about 2 MHz.

50. The identifiable object for an identification system according to claim 28, where the at least one output signal comprises a coded signal.

51. A method for identifying an identifiable object having at least one photo-activated microtransponder operatively connected to an article, comprising:
activating the at least one photo-activated microtransponder with at least one light signal;
transmitting at least one output signal responsive to the at least one light signal; and
detecting the at least one output signal.

52. The method according to claim 51, where the at least one light signal comprises at least one LASER.

53. The method according to claim 51, where the at least one light signal comprises at least one LED.

54. The method according to claim 51, where the at least one output signal comprises at least one of an electronic signal, magnetic signal, and light signal.
